(19) United States
(12) Patent Application Publication
(10) Pub. No.: US 2007/0116406 A1
(43) Pub. Date: May 24, 2007

(54) Switch

(75) Inventors: Yu Yonezawa, Yokohama (JP); Naoyuki Mishima, Yokohama (JP); Tadashi Nakatani, Kawasaki (JP); Anh Tuan Nguyen, Kawasaki (JP); Satoshi Ueda, Kawasaki (JP)

Correspondence Address: ARENT FOX PLLC, 1050 CONNECTICUT AVENUE, N.W., SUITE 400, WASHINGTON, DC, 20036, US

(73) Assignee: FUJITSU MEDIA DEVICES LIMITED & FUJITSU LIMITED

(21) Appl. No.: 11/603,063

(22) Filed: Nov. 22, 2006

(30) Foreign Application Priority Data
Nov. 24, 2005 (JP) 2005-338532

(51) Int. Cl. G02B 6/26

(52) U.S. Cl. 385/18

(57) ABSTRACT

A switch includes multiple torsion springs with each of one ends thereof secured to a substrate, a beam portion, to which each of the other ends of the multiple torsion springs is secured, and which is swung by an electrostatic actuator, and a switch contact portion in which a first contact provided at the beam portion and a second contact secured to the substrate are in connection or disconnection.

### BACKGROUND OF THE INVENTION

1. Field of the Invention

This invention generally relates to switches, and more particularly, to a switch that is mechanically driven and electrically coupled.

2. Description of the Related Art

In recent years, with the advancements of mobile communications systems, portable information terminals or the like are rapidly wide spreading. For instance, the mobile telephone systems utilize high-frequency bandwidths such as 800 MHz to 1 GHz and 1.5 GHz to 2.0 GHz. So, high-frequency switches are for use in the devices of the mobile communications systems. There is a demand for the high frequency switches in which the sizes are reduced and power is saved, and semiconductor switches with gallium arsenide (GaAs) or the like have been conventionally used. The semiconductor switches, however, have a high power loss and a low isolation. For these reasons, developments of high frequency microelectromechanical system (MEMS) switches are in progress by use of MEMS technology, so that miniaturization, low power loss, and high isolation can be achieved.

As disclosed in Japanese Patent Application Publication No. 2005-243576 and Japanese Patent Application Publication No. 2003-522377, there have been proposed MEMS switches having a cantilever beam, which is a movable beam with one end thereof secured to the substrate. The MEMS switches use Silicon-On-Insulator (SOI) substrate, and the cantilever beam is formed of the upper silicon layer. A thin film electrode of Au is provided at an end of the cantilever beam, and the upper electrode is fabricated by Au plating at the upper portion of the thin film electrode. A switch contact portion is configured in such a manner that the thin film electrode and the upper electrode are in connection or disconnection. The cantilever beam is driven by an electrostatic actuator or electromagnetic actuator. For example, the electrostatic actuator includes the lower electrode on the cantilever beam and the upper electrode above the cantilever beam. The cantilever beam is driven by supplying a voltage between the upper electrode and the lower electrode.

There is a demand for the MEMS switches in which the driving power is reduced, namely, the power consumption is reduced, the stability is enhanced, and the sizes are reduced. Generally, when the drive voltage is decreased, the contact operation of the switch contact portion becomes unstable. For example, even if a small power is generated from the actuator to decrease the drive voltage of the MEMS switch, the switch contact portion needs to be operable. As a method thereof, the spring constant of the movable beam portion is reduced. Such reduced spring constant of the movable beam portion, however, weakens the opening force when the switch contact portion is opened. This may cause the phenomenon of being unopened and lead to unstable contact operation, when the switch contact portion is opened and closed a number of times. As described above, the reduced drive voltage and the stable contact operation at the switch contact portion are in a trade-off relationship.

There has been proposed a method of suppressing the power consumption during operation in the switch having an electromagnetic actuator by use of a latch structure with hysteresis characteristics in the electromagnetic actuator. Also, there has been proposed a seesaw structure with a hinge to realize the latch structure. Nevertheless, the magnetic thin film or coil cannot be easily reduced in size, even if the above-described method or structure is employed. It is difficult to reduce the MEMS switches in size.

Meanwhile, the electrostatic actuator has a simple structure, the fabrication thereof is easy, and the size thereof can be reduced. There is a method of reducing the gap between the electrodes of the electrostatic actuator to reduce the drive voltage of the electrostatic actuator. However, when the gap between the electrodes is narrowed, there may cause a sticking problem while the electrostatic actuator is being fabricated.

### SUMMARY OF THE INVENTION

The present invention has been made in view of the above circumstances and provides a switch in which the size thereof can be reduced, the drive voltage thereof can be reduced, or the contact operation at the switch contact portion thereof can be stably performed.

According to one aspect of the present invention, there is provided a switch including: multiple torsion springs with each of one ends thereof secured to a substrate; a beam portion, to which each of the other ends of the multiple torsion springs is secured, and which is swung by an electrostatic actuator; and a switch contact portion in which a first contact provided at the beam portion and a second contact secured to the substrate are in connection or disconnection. Downsizing is enabled by employing the electrostatic actuator. Even if the voltage to be applied to the electrostatic actuator is small, the beam portion can be driven with the reduced spring constant because the spring contact becomes smaller. This enables the drive voltage to be reduced.

### BRIEF DESCRIPTION OF THE DRAWINGS

Preferred exemplary embodiments of the present invention will be described in detail with reference to the following drawings, wherein:

FIG. 1 is a top view of a switch in accordance with a first exemplary embodiment of the present invention;

FIG. 2A is a cross-sectional view taken along the line A-A shown in FIG. 1;

FIG. 2B is a cross-sectional view taken along the line B-B shown in FIG. 1;

FIG. 2C is a cross-sectional view taken along the line C-C shown in FIG. 1;

FIG. 3A through FIG. 3E are cross-sectional views showing a fabrication method of the switch employed in the first exemplary embodiment of the present invention;

FIG. 4A and FIG. 4B respectively show a torsion spring structure and a cantilever beam structure used for calculation of spring constant;

FIG. 5 shows calculation results of the spring constants of the two structures with respect to the beam length of a beam portion;

FIG. 6 schematically shows a circuit diagram when the switch employed in the first exemplary embodiment is operated;

FIG. 7A and FIG. 7B respectively show timing charts when the switch employed in the first exemplary embodiment is operated;

FIG. 8 is a perspective view of the switch in accordance with a second exemplary embodiment of the present invention;

FIG. 9 is a perspective view of the switch in accordance with a third exemplary embodiment of the present invention;

FIG. 10 is a perspective view of the switch in accordance with a fourth exemplary embodiment of the present invention;

FIG. 11 is a perspective view of the switch in accordance with a fifth exemplary embodiment of the present invention; and

FIG. 12 is a perspective view of the switch in accordance with a sixth exemplary embodiment of the present invention.

### DESCRIPTION OF THE PREFERRED EMBODIMENTS

A description will now be given, with reference to the accompanying drawings, of exemplary embodiments of the present invention.

### First Exemplary Embodiment

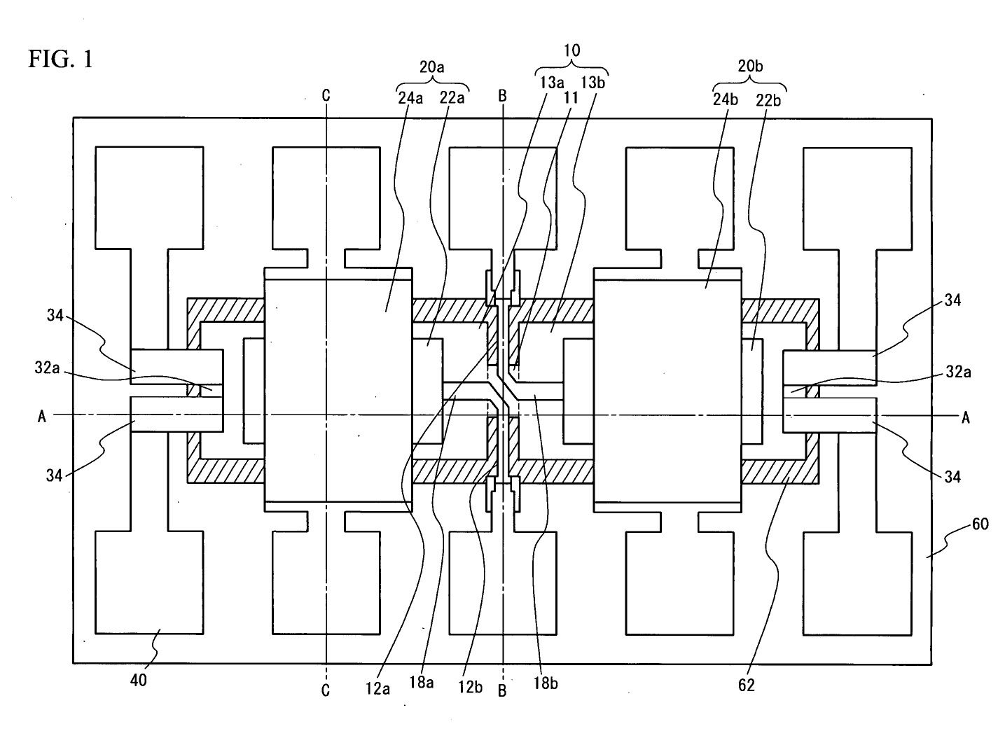

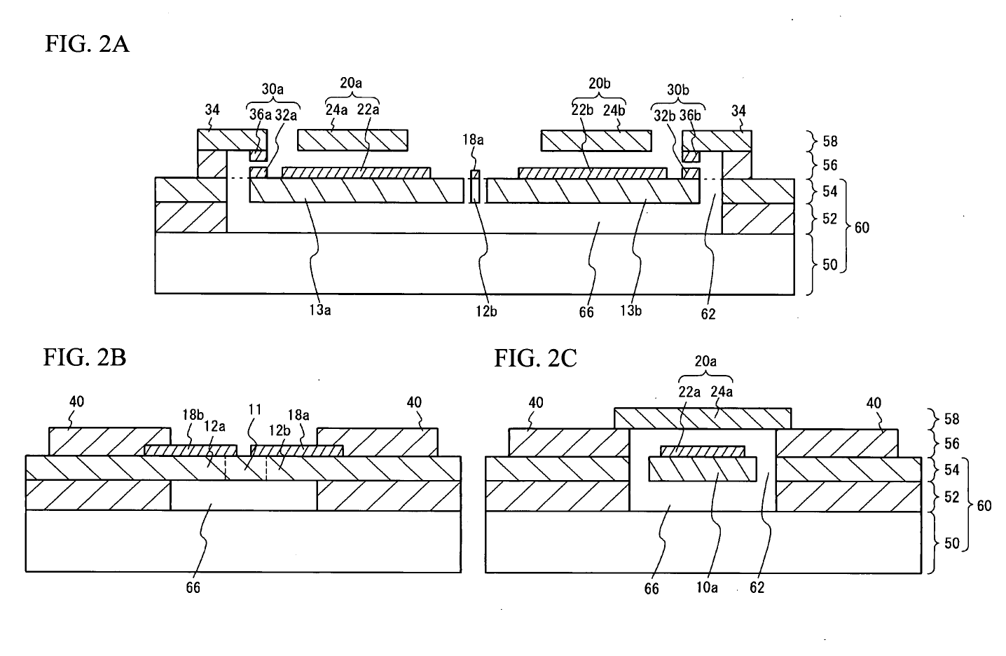

A description will be given, with reference to FIG. 1, FIG. 2A through FIG. 2C, of a configuration of a switch in accordance with a first exemplary embodiment of the present invention. FIG. 1 is a top view of the switch employed in the first exemplary embodiment of the present invention. FIG. 2A is a cross-sectional view taken along the line A-A shown in FIG. 1. FIG. 2B is a cross-sectional view taken along the line B-B shown in FIG. 1. FIG. 2C is a cross-sectional view taken along the line C-C shown in FIG. 1.

As shown in FIG. 2A through FIG. 2C, the switch employed in the first exemplary embodiment has a Silicon-On-Insulator (SOI) substrate 60, in which there are provided: a silicon substrate 50; a silicon oxide layer 52; and a silicon layer 54. In addition, the switch employed in the first exemplary embodiment has a stacked structure in which metal layers 56 and 58 are stacked on the SOI substrate 60. The silicon substrate 50 may have a thickness of, for example, 600 μm, the silicon oxide layer 52 may have a thickness of, for example, 4 μm, the silicon layer 54 may have a thickness of, for example, 15 μm, the metal layer 56 may have a thickness of, for example, 20 μm, and the metal layer 58 may have a thickness of, for example, 20 μm.

Referring to FIG. 1 and FIG. 2B, two torsion springs 12a and 12b are formed of the silicon layer 54, and each of one ends thereof is secured to the SOI substrate 60. Here, the torsion spring demonstrates spring characteristics by twisting. Each of the other ends of the torsion springs 12a and 12b is secured to a common portion 11 in a beam portion 10. The silicon oxide layer 52 arranged below the torsion springs 12a and 12b and below the beam portion 10 is removed, and a cavity 66 is defined. Referring to FIG. 1 and FIG. 2A, the beam portion 10 includes: sub beam portions 13a and 13b; and the common portion 11 to which each of one ends of the sub beam portions 13a and 13b is secured, and the beam portion 10 is integrally formed of the silicon layer 54 to be a rigid body. The silicon oxide layer 52 below the torsion springs 12a and 12b and below the beam portion 10 is removed and the cavity 66 is defined. In the periphery of the beam portion 10, the silicon oxide layer 52 is removed except the torsion springs 12a and 12b, and slits 62 are formed. The beam portion 10 is surrounded by the slits 62 and the cavity 66, except the portion held by the torsion springs 12a and 12b. In other words, the beam portion 10 is held by the torsion springs 12a and 12b only. The sub beam portions 13a and 13b are provided at both sides of the common portion 11.

Referring to FIG. 1, FIG. 2A, and FIG. 2C, there are respectively provided a lower electrode 22a of an electrostatic actuator 20a, and a lower electrode 22b of an electrostatic actuator 20b on top surfaces of the sub beam portions 13a and 13b. There are respectively provided upper electrodes 24a and 24b, formed of the metal layer 58, above the lower electrodes 22a and 22b. The electrostatic actuator 20a is formed of the lower electrode 22a and the upper electrode 24a, and the electrostatic actuator 20b is formed of the lower electrode 22b and the upper electrode 24b. Referring to FIG. 2C, the upper electrodes 24a and 24b are respectively secured through the metal layer 56 provided at both sides of the sub beam portions 13a and 13b to the SOI substrate 60, and are electrically coupled to pads 40. Referring to FIG. 1 and FIG. 2B, the lower electrodes 22a and 22b are electrically coupled to the pads 40 respectively by wiring electrodes 18a and 18b. The wiring electrodes 18a and 18b are respectively provided on the torsion springs 12b and 12a. Referring back to FIG. 1 and FIG. 2A, the electrostatic actuators 20a and 20b are respectively driven by the voltages supplied to the lower electrodes 22a and 22b and the upper electrodes 24a and 24b. Then, the electrostatic actuators 20a and 20b swings up and down the beam portion 10.

Referring to FIG. 1 and FIG. 2A, a first contact 32a is arranged at an end of the sub beam portion 13a. A second contact 36a is arranged on the first contact 32a. The second contact 36a is provided in an upper layer 34 composed of the metal layers 58 and 56. The second contact 36a is secured through the upper layer 34 to the SOI substrate 60, and is electrically coupled to the pad 40. The first contact 32a and the second contact 36a compose a switch contact portion 30a. Two second contacts 36a are provided to one first contact 32a. When the sub beam portion 13a is driven upward, the first contact 32a and the second contacts 36a are in connection. Then, one of the upper layers 34, one of the second contacts 36a, and one of the first contact 32a become conductive, and each of the other second contacts 36a and the other upper layer 34 becomes conductive. Then, the switch contact portion 30a is in connection. Meanwhile, when the first contact 32a and the second contacts 36a are in disconnection, the switch contact portion 30a is in disconnection. A switch contact portion 30b provided to the sub beam portion 13b operates in a similar manner.

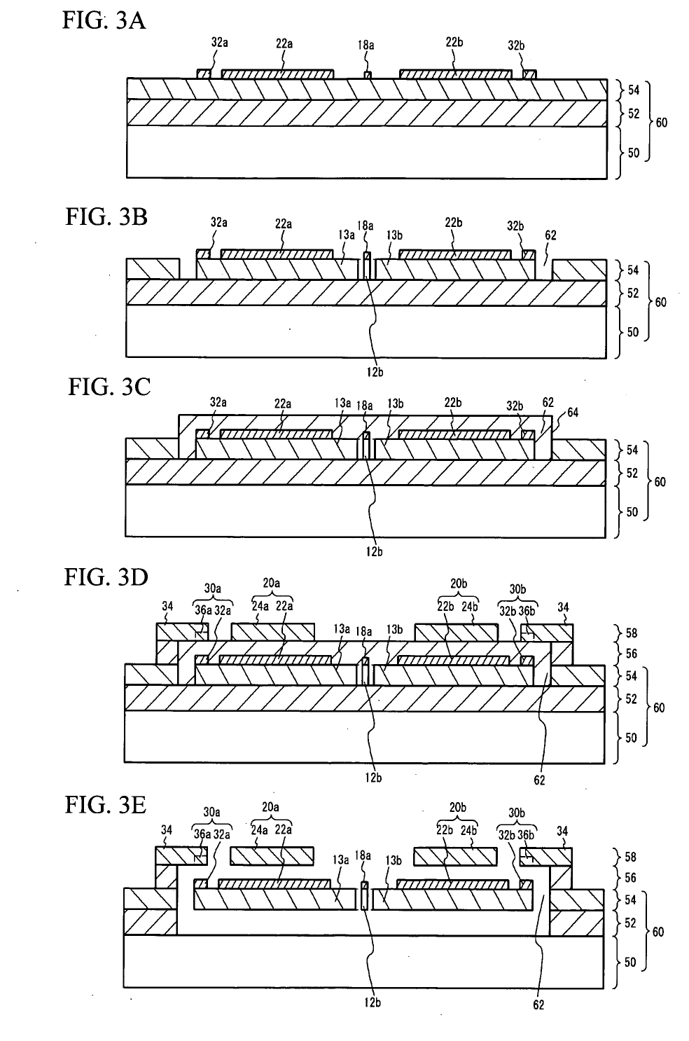

A description will now be given of a fabrication method of the switch employed in the first exemplary embodiment of the present invention. FIG. 3A through FIG. 3E show the fabrication method of the switch employed in the first exemplary embodiment of the present invention. FIG. 3A through FIG. 3E are cross-sectional views taken along the line A-A shown in FIG. 1. Referring now to FIG. 3A, a metal thin film of, for example, Mo, Au, or the like is formed on the SOI substrate 60 composed of: the silicon substrate 50; the silicon oxide layer 52; and the silicon layer 54. The first contacts 32a and 32b, the lower electrodes 22a and 22b, and the wiring electrodes 18a and 18b are formed by use of the lithography and etching techniques.

Referring now to FIG. 3B, the slits 62 are formed in the silicon layer 54, in the periphery of the beam portion 10 and the torsion springs 12a and 12b. The slits 62 are formed by use of the lithography and etching techniques. Referring now to FIG. 3C, a sacrifice layer 64 formed, for example, of a silicon oxide film and having a thickness of several microns is formed by plasma Chemical Vapor Deposition (CVD). Then, a given region of the sacrifice layer 64 is removed by use of the lithography and etching techniques.

Referring now to FIG. 3D, a photoresist is formed in a given region and Au is formed by plating. By this process, the upper layer 34 and the upper electrodes 24a and 24b are formed. Referring now to FIG. 3E, the sacrifice layer 64 and the silicon oxide layer 52 are removed by use of a hydrofluoric acid based etchant. By this process, the silicon oxide layer 52 arranged below the beam portion 10 is removed and the cavity 66 is defined. As described heretofore, the switch employed in the first exemplary embodiment is fabricated.

In FIG. 3D and FIG. 3E, the second contacts 36a and 36b are provided in the upper layer 34. The second contacts 36a and 36b may be included in the upper layer 34 as described. When the second contacts 36a and 36b are provided at the lower surface of the upper layer 34 as shown in FIG. 2A, recess portions are provided to form the second contacts 36a and 36b in the sacrifice layer 64. Subsequently, the processes shown in FIG. 3D and FIG. 3E are performed. It is therefore possible to arrange the second contacts 36a and 36b at the lower surface of the upper layer 34.

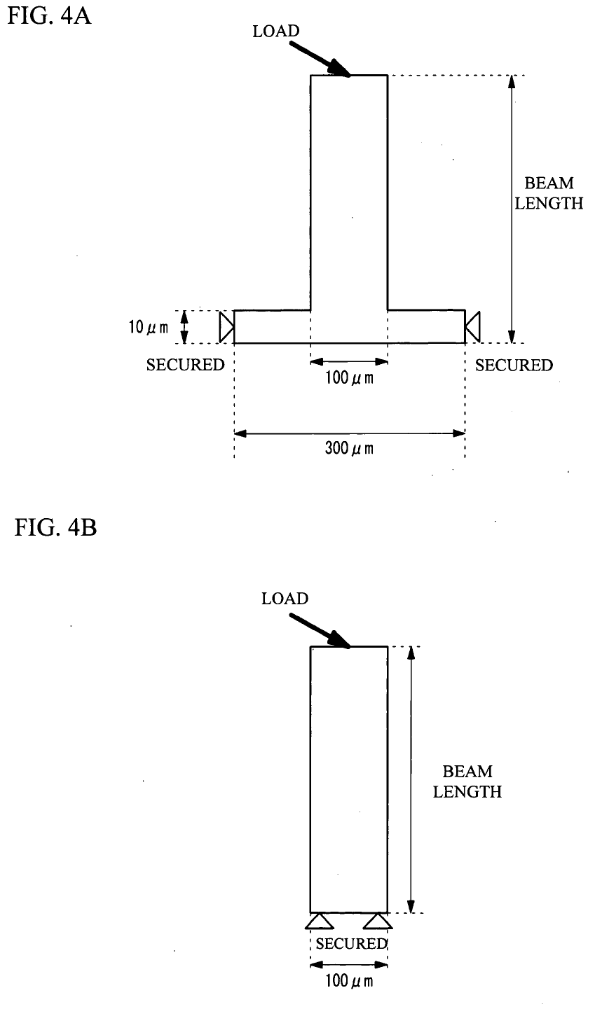

Here, the calculation is executed and compared between the spring constant of the torsion structure in which the beam portion is held by the torsion springs 12a and 12b and that of the cantilever beam structure in which each of one ends of the torsion springs 12a and 12b is secured. FIG. 4A and FIG. 4B respectively show the torsion spring structure and the cantilever beam structure used for the calculation. Referring to FIG. 4A, the beam portion held by the torsion springs is made of silicon with a width of 100 μm and a thickness of 15 μm. Two ends thereof at one side are secured to the two torsion springs, and the other end at the other side is loaded. There are provided two tension springs, each of which has a length of 100 μm, a width of 10 μm, and a thickness of 15 μm. Each one end of the two torsion springs is secured to the beam portion, and each of the other ends thereof is secured to, for example, the substrate. Referring to FIG. 4B, the cantilever beam is made of silicon with a width of 100 μm and a thickness of 15 μm. One end of the cantilever beam is secured and each of the other end thereof is loaded.

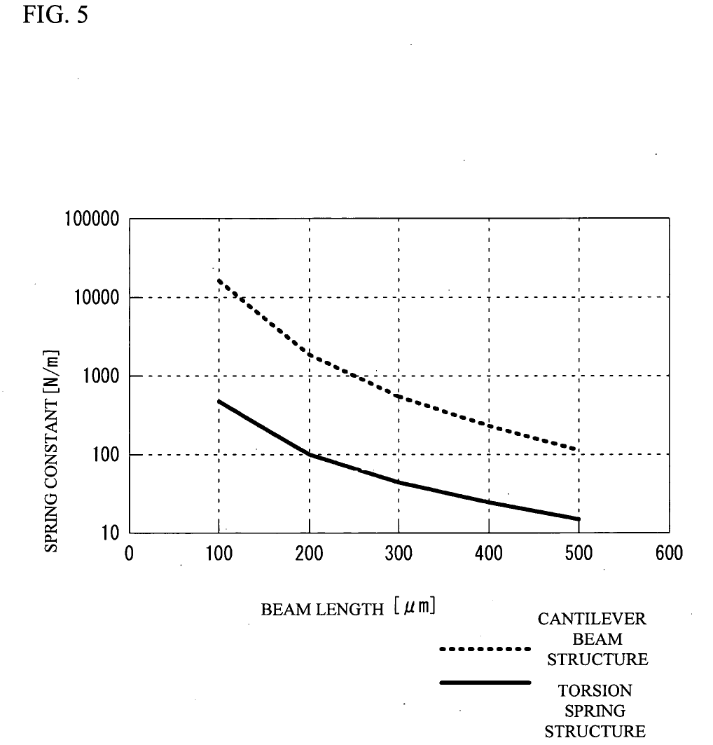

FIG. 5 shows calculation results of the spring constants of the above-described two structures with respect to the beam length of the beam portion. In both of the torsion spring structure and the cantilever beam structure, the longer the beam length, the smaller the spring constant. The spring constant of the torsion spring structure can be reduced by one digit or more as compared to that of the cantilever beam structure.

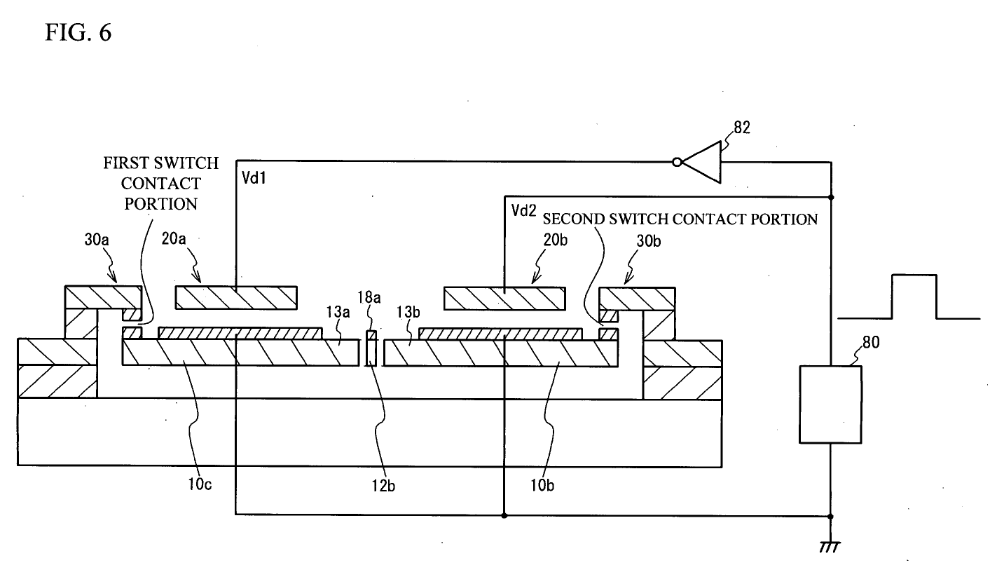

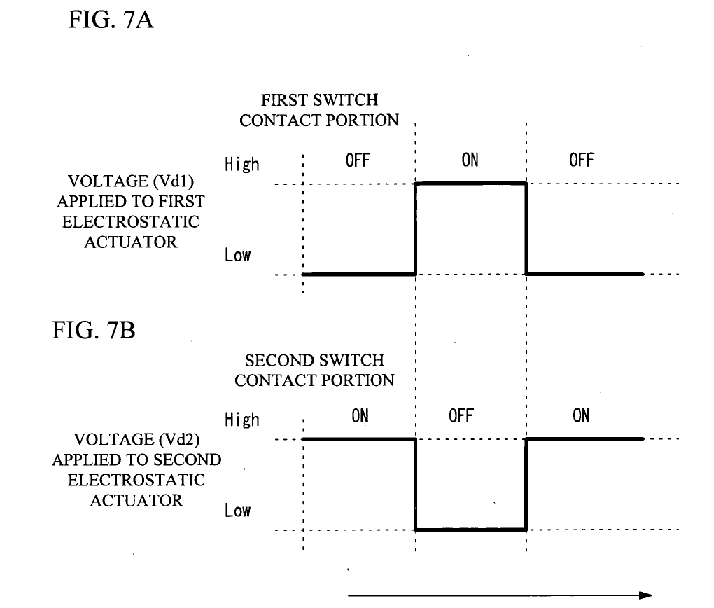

A description will now be given, with reference to FIG. 6, FIG. 7A, and FIG. 7B, of the operation of the switch employed in the first exemplary embodiment of the present invention. FIG. 6 schematically shows a circuit diagram when the switch employed in the first exemplary embodiment is operated. Hereinafter, in FIG. 6, the same components and configurations as those employed in FIG. 2A have the same reference numerals and a detailed explanation will be omitted. As shown in FIG. 6, a drive signal Vd2 is input from a signal generator 80 into the electrostatic actuator 20b (hereinafter, referred to as second electrostatic actuator) provided at the sub beam portion 13b, which is one of the sub beam portions 13a and 13b opposing each other and interposing the common portion 11 of the switch employed in the first exemplary embodiment. A drive signal Vd1 is input into the electrostatic actuator 20a (hereinafter, referred to as first electrostatic actuator) provided at the other sub beam portion 13a, whereas the drive signal Vd1 is an inverted signal of the signal generator 80 and inverted at an inverter 82. The high level and low level of the drive signal may be configured as, for example, TTL level.

FIG. 7A and FIG. 7B respectively show the voltage Vdl applied to the first electrostatic actuator 20a and the voltage Vd2 applied to the second electrostatic actuator 20b. The voltage Vd2 is passed through the inverter and turned into the voltage Vd1. That is, the Vd1 and Vd2 function as inverted signals. When the voltage Vd1 is a low voltage and the voltage Vd2 is a high voltage, a repulsive force is applied to the first electrostatic actuator 20a and an attractive force is applied to the second electrostatic actuator 20b. For this reason, the switch contact portion 30a (hereinafter, referred to as first switch contact portion) is in disconnection (turned off), whereas the switch contact portion 30b (hereinafter, referred to as second switch contact portion) is in connection (turned on). Meanwhile, when the voltage Vd1 is a high voltage and the voltage Vd2 is a low voltage, an attractive force is applied to the first electrostatic actuator 20a and a repulsive force is applied to the second electrostatic actuator 20b. For this reason, the switch contact portion 30a is in connection (turned on), whereas the switch contact portion 30b is in disconnection (turned off).

In the switch employed in the first exemplary embodiment, the beam portion 10 is driven by the electrostatic actuators 20a and 20b, and each of one ends of the torsion springs 12a and 12b is secured to the SOI substrate 60 and the other ends thereof are secured to the beam portion 10. As shown in FIG. 5, by employing the torsion spring structure, the spring constant is made smaller. Even if a small voltage is applied to the electrostatic actuators 20a and 20b, it is possible to activate the beam portion. This enables the drive voltage to be reduced. Here, in the first exemplary embodiment, a description has been given of a case where there are provided two sub beam portions 13a and 13b, two electrostatic actuators 20a and 20b, and two switch contact portions 30a and 30b. However, there may be provided at least one sub beam portion, at least one electrostatic actuator, and at least one switch contact portion. If there are provided at least one electrostatic actuator, and at least one switch contact portion and the torsion spring structure is employed, the spring constant is made smaller and the drive voltage can be reduced.

The switch employed in the first exemplary embodiment has the beam portion 10 provided with: two sub beam portions 13a and 13b; and the common portion 11 to which each of one ends of the sub beam portions 13a and 13b is secured. The common portion 11 is connected and held by the two torsion springs 12a and 12b. The two sub beam portions 13a and 13b respectively include: the electrostatic actuators 20a and 20b; and the first contacts 32a and 32b. In addition, the switch contact portions 30a and 30b are respectively provided to correspond to the first contacts 32a and 32b respectively arranged at the sub beam portions 13a and 13b. With such configuration, when the first switch contact portion 30a is in connection, the second switch contact portion 30b is in disconnection. When the second switch contact portion 30b is in connection, the first switch contact portion 30a is in disconnection. In this manner, the switch employed in the first exemplary embodiment functions as a Single-Pole Double-Throw (SPDT) switch.

Furthermore, as shown in FIG. 7A and FIG. 7B, when a high voltage (first voltage) is applied to the first electrostatic actuator 20a, a low voltage (second voltage) is applied to the second electrostatic actuator 20b. When a low voltage (third voltage) is applied to the first electrostatic actuator 20a, a high voltage (fourth voltage) is applied to the second electrostatic actuator 20b. Accordingly, when a high voltage is applied to the first electrostatic actuator 20a and a low voltage is applied to the second electrostatic actuator 20b, the first switch contact portion 30a is in disconnection (off state) and the second switch contact portion 30b is in connection (on state). Meanwhile, when a high voltage is applied to the first electrostatic actuator 20a and a low voltage is applied to the second electrostatic actuator 20b, the first switch contact portion 30a is in connection (on state) and the second switch contact portion 30b is in disconnection (off state).

The first voltage and the fourth voltage may be different, and the second voltage and the third voltage may be different. However, preferably, the first voltage and the fourth voltage are same, and the second voltage and the third voltage are same in accordance with the first exemplary embodiment. This is because the first switch contact portion 30a and the second switch contact portion 30b can be in connection by means of the same force.

As shown in FIG. 7A and FIG. 7B, preferably, the voltage Vd1 applied to the first electrostatic actuator 20a is changed from a high voltage (first voltage) to a low voltage (third voltage) and the voltage Vd2 applied to the second electrostatic actuator 20b is changed from a low voltage (second voltage) to a high voltage (fourth voltage) at the same time. Also, preferably, the voltage Vd1 applied to the first electrostatic actuator 20a is changed from a low voltage (third voltage) to a high voltage (first voltage) and the voltage Vd2 applied to the second electrostatic actuator 20b is changed from a high voltage (fourth voltage) to a low voltage (second voltage) at the same time. At the moment when the voltage Vd2 becomes a high voltage and an attractive force is exerted onto the first electrostatic actuator 20a, the voltage Vd1 becomes a low voltage and a repulsive force is exerted onto the second electrostatic actuator 20b. This allows the two electrostatic actuators 20a and 20b to exert the forces to open the switch contact portions 30a and 30b. Accordingly, even in a switch of the torsion spring structure with a small spring constant, it is possible to suppress the phenomenon of being unopened when the switch contact portion is opened and closed a number of times.

In accordance with the first exemplary embodiment of the present invention, the first drive signal Vdl that drives the first electrostatic actuator 20a is applied to the first electrostatic actuator 20a, and the second drive signal Vd2 that drives the second electrostatic actuator 20b is applied to the second electrostatic actuator 20b. There is provided the inverter 82 that inverts the first drive signal Vd1 and outputs the second drive signal Vd2. The first drive signal Vd1 is inverted to generate the second drive signal Vd2 by use of the inverter 82, thereby making it possible to change the second drive signal Vd2 to a low voltage at a moment when the first voltage Vd1 becomes a high voltage and to change the second drive signal Vd2 to a high voltage at a moment when the first voltage Vd1 becomes a low voltage, with the above-described simple configuration.

### Second Exemplary Embodiment

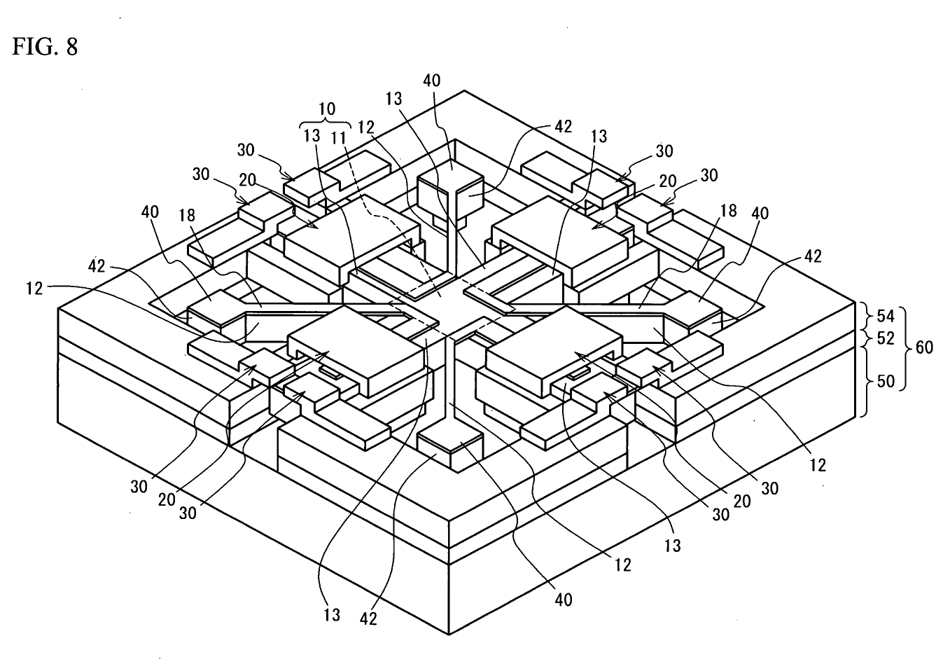

There are provided four sub beam portions in accordance with a second exemplary embodiment of the present invention. FIG. 8 is a perspective view of the switch in accordance with the second exemplary embodiment of the present invention. The beam portion 10 includes: four sub beam portions 13; and the common portion 11 to which each of one ends of the four sub beam portions 13 is secured. Four torsion springs 12 are secured to the common portion 11. Each one end of the four torsion springs 12 is secured to the common portion 11, and each of the other ends is secured through a fixed portion 42 to the SOI substrate 60. The fixed portion 42 is composed of: the silicon layer 54; and the silicon oxide layer 52, and is secured to the silicon substrate 50. The beam portion 10 and the torsion springs 12 are formed of the silicon layer 54, and the silicon oxide layer 52 arranged below the beam portion 10 and below the torsion spring 12 is removed and a cavity is defined. For this reason, the beam portion 10 is held only by the torsion springs 12 secured through the fixed portion 42 to the SOI substrate 60. The electrostatic actuators 20 and the switch contact portions 30 have the same configurations as those employed in the first exemplary embodiment, and a detailed explanation will be omitted.

In the switch employed in the second exemplary embodiment, two electrostatic actuators 20 provided at the two sub beam portions opposing each other and interposing the common portion 11 are operated as described with reference to FIG. 6, FIG. 7A and FIG. 7B in the first exemplary embodiment. At this time, it is preferable that no drive signal be input into any electrostatic actuator, except the two opposing electrostatic actuators being operated. In this manner, the switch employed in the second exemplary embodiment functions as a Single-Pole Four-Throw (SP4T) switch. The number of the sub beam portions 13 and that of the switch contact portions 30 are not limited to four. For instance, when the switch includes N (two or more) sub beam portions 13 and N (two or more) switch contact portions 30, the switch functions as a Single-Pole N-Throw (SPNT) switch. As described heretofore; the SPNT switch can be integrated and fabricated onto a single substrate.

In accordance with the first and second exemplary embodiments, it may be configured that the sub beam portion and the torsion spring be alternately secured to the common portion 11. By this configuration, the beam portion 10 is held by the torsion springs 12 in a well-balanced manner.

### Third Exemplary Embodiment

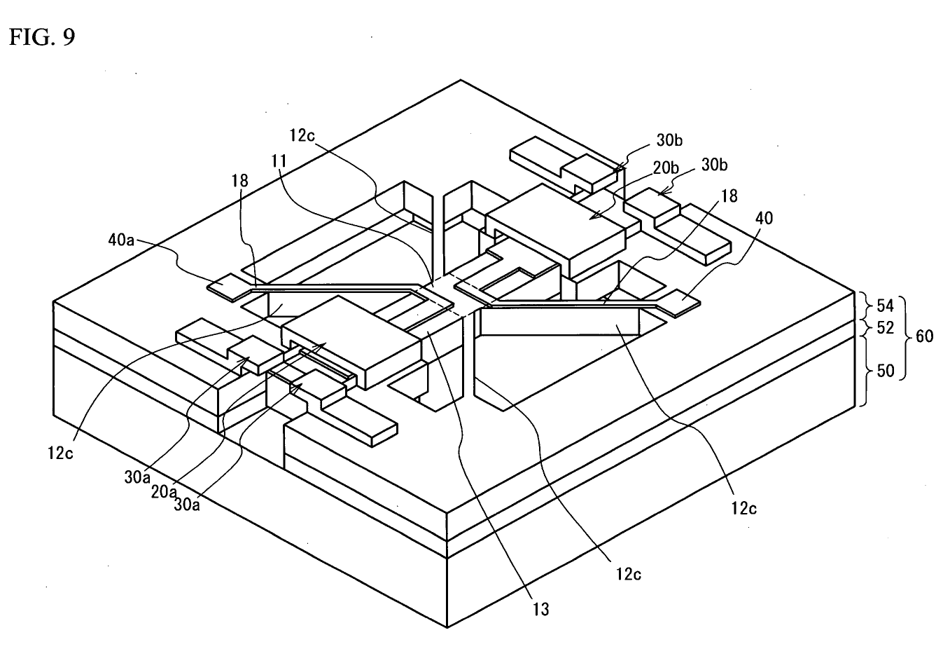

There are arranged two torsion springs in a V-shaped manner in accordance with a third exemplary embodiment of the present invention. FIG. 9 is a perspective view of the switch in accordance with a third exemplary embodiment of the present invention. There are two torsion springs 12c respectively provided at both sides of the common portion 11 of the beam portion 10 with each of one ends thereof secured to the common portion 11 in close proximity to each other. The other ends of the torsion springs 12c are secured to the SOI substrate 60 apart from each other. In this manner, two torsion springs 12c are arranged in a V-shaped manner. In the third exemplary embodiment, the same components and configurations as those employed in the first exemplary embodiment have the same reference numerals and a detailed explanation will be omitted.

### Fourth Exemplary Embodiment

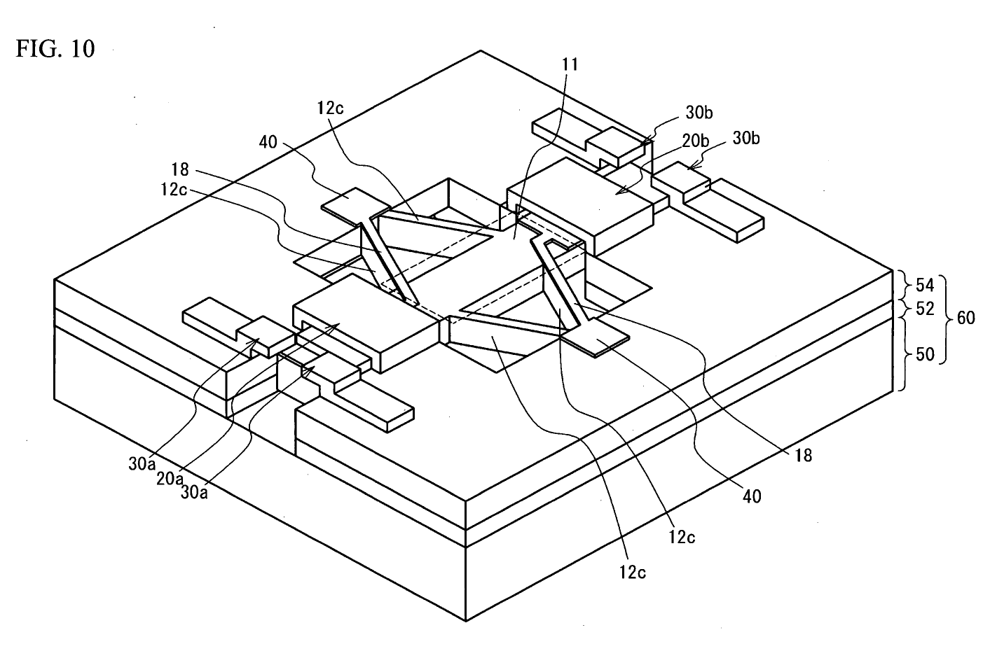

There are arranged two torsion springs in a V-shaped manner in accordance with a third exemplary embodiment of the present invention. FIG. 10 is a perspective view of the switch in accordance with a third exemplary embodiment of the present invention. There are two torsion springs 12c respectively provided at both sides of the common portion 11 of the beam portion 10 with each of one ends thereof secured to the common portion 11 apart from each other. The other ends of the torsion springs 12c are secured to the SOI substrate 60 in close proximity to each other. In this manner, two torsion springs 12c are arranged in a V-shaped manner. In the fourth exemplary embodiment, the same components and configurations as those employed in the first exemplary embodiment have the same reference numerals and a detailed explanation will be omitted.

In accordance with the third and fourth exemplary embodiments, preferably, two torsion springs arranged in a V-shaped manner are secured in the beam portion 10. This makes it possible to prevent the beam portion 10 from being displaced in a horizontal direction. The torsion springs 12c arranged in a V-shaped manner may be employed for the switch having three or more sub beam portions 13, for example, employed in the second exemplary embodiment.

### Fifth Exemplary Embodiment

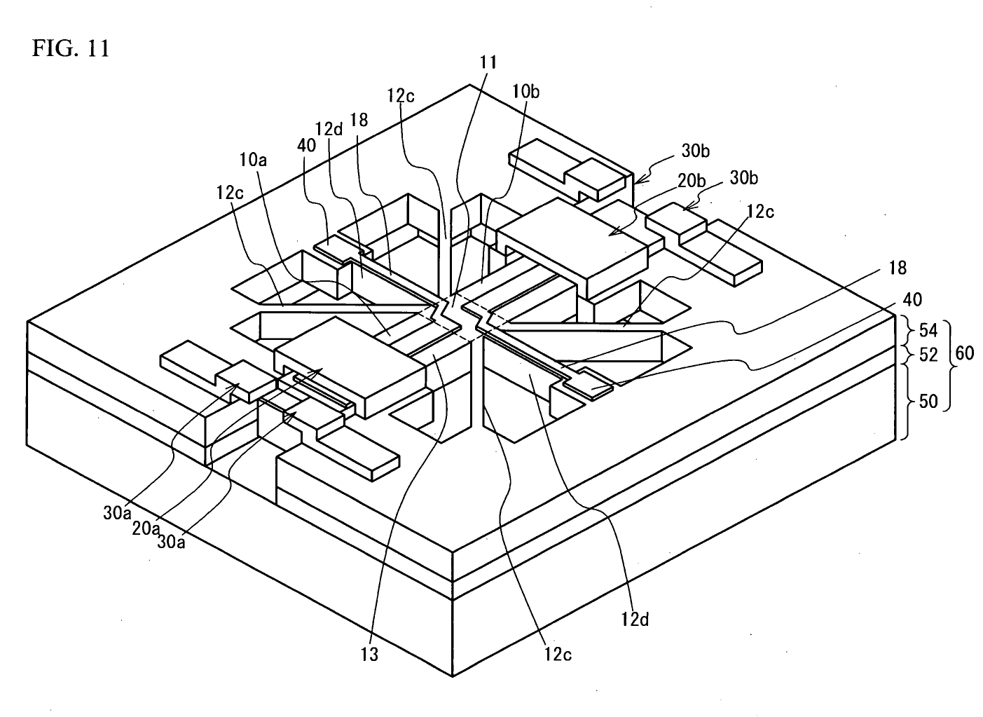

There is provided another torsion spring 12d between the two torsion springs 12c arranged in a V-shaped manner in accordance with a fifth exemplary embodiment of the present invention. FIG. 11 is a perspective view of the switch in accordance with the fifth exemplary embodiment of the present invention. There are two torsion springs 12c respectively provided at both sides of the common portion 11 of the beam portion 10 with each of one ends thereof secured to the common portion 11 in close proximity to each other. There is also provided the torsion spring 12d between the two torsion springs 12c arranged in a V-shaped manner, with one end thereof secured to the common portion 11. The other ends of the torsion springs 12c and 12d are secured to the SOI substrate 60 apart from each other. In the fifth exemplary embodiment, the same components and configurations as those employed in the third exemplary embodiment have the same reference numerals and a detailed explanation will be omitted.

In accordance with the fifth exemplary embodiment, it is further possible to prevent the beam portion 10 from being displaced in a horizontal direction, by providing the torsion spring 12d between the two torsion springs 12c arranged in a V-shaped manner. The two torsion springs 12c arranged in a V-shaped manner may be provided with each of one ends thereof secured to the beam portion 10 apart from each other and the other ends thereof secured to the SOI substrate 60 in close proximity to each other, as described in the fourth exemplary embodiment. Two or more torsion springs 12d may be provided between the two torsion springs 12c arranged in a V-shaped manner. As the number of the torsion springs 12d is increased, the displacement toward a horizontal direction can be further prevented. The spring constant, however, is increased. The number of the torsion springs 12d may be determined in consideration of the displacement toward a horizontal direction and the spring constant. In addition, the above-described one or more torsion springs 12d provided between the two torsion springs 12c arranged in a V-shaped manner may be employed for the switch having three or more sub beam portions 13, for example, as employed in the second exemplary embodiment.

### Sixth Exemplary Embodiment

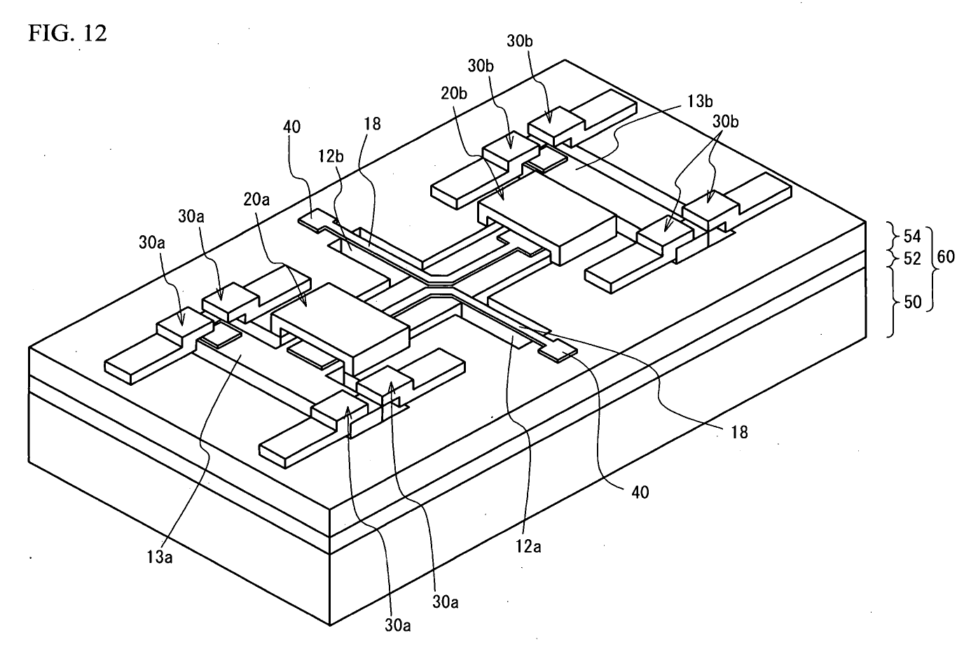

The sub beam portion includes multiple switch contact portions, which are electrically isolated from each other, in accordance with a sixth exemplary embodiment of the present invention. FIG. 12 is a perspective view of the switch in accordance with the sixth exemplary embodiment of the present invention. The sub beam portions 13a and 13b respectively have a substantially T-shape. Two switch contact portions 30a are respectively provided at two ends of one side of the substantially T-shaped sub beam portion 13a. The two switch contact portions 30a are electrically isolated from each other, and are simultaneously in connection or disconnection. Two switch contact portions 30b provided at the sub beam portion 13b are configured in a similar manner. In the sixth exemplary embodiment, the same components and configurations as those employed in the first exemplary embodiment have the same reference numerals and a detailed explanation will be omitted.

The switch employed in the sixth exemplary embodiment serves as a double switch in which electrically isolated two switch contact portions 30a or 30b are in connection or disconnection. Three or more (namely, N) switch contact portions 30 electrically isolated may be provided at one sub beam portion 13. In this case, the switch serves as an N-series switch. In addition, the switch contact portions employed in the present exemplary embodiment may be applicable to the SPNT switch having three or more sub beam portions 13, as described in the second exemplary embodiment. Furthermore, it is only necessary that there be provided electrically isolated two switch contact portions 30 in at least one sub beam portion 13.

In accordance with the first through sixth exemplary embodiments, a wiring electrode 18 may be arranged on the torsion spring 12, the wiring electrode 18 being electrically coupled to a lower electrode 22 of the electrostatic actuator 20 provided in the beam portion 10. This makes it possible to provide the wiring electrode 18 on the SOI substrate 60, whereas the wiring electrode 18 is electrically coupled to the lower electrode 22. The shape of the torsion spring is not limited to a square pole used in the first through sixth exemplary embodiments. The torsion spring may be a spring that demonstrates spring characteristics by twisting.

Finally, various aspects of the present invention are summarized in the following.

According to an aspect of the present invention, there is provided a switch including: multiple torsion springs with each of one ends thereof secured to a substrate; a beam portion, to which each of the other ends of the multiple torsion springs is secured, and which is swung by an electrostatic actuator; and a switch contact portion in which a first contact provided at the beam portion and a second contact secured to the substrate are in connection or disconnection.

In the above-described switch, the beam portion may include multiple sub beam portions and a common portion to which each of the one ends of the multiple sub beam portions is secured; the multiple torsion springs are secured to the common portion; the multiple sub beam portions respectively include the electrostatic actuator and the first contact; and multiple switch contact portions are provided to the first contact respectively provided at the multiple sub beam portions. When N sub beam portions are provided, a SPNT switch can be fabricated and integrated on a single substrate.

In the above-described switch, the multiple sub beam portions may be two beam portions. The SPNT switch can be fabricated and integrated on a single substrate.

In the above-described switch, a first electrostatic actuator may be provided at one of two sub beam portions opposing each other and interposing the common portion and a second electrostatic actuator is provided at the other of the two sub beam portions; when a first voltage is applied to the first electrostatic actuator, a second voltage is applied to the second electrostatic actuator; when a third voltage is applied to the first electrostatic actuator, a fourth voltage is applied to the second electrostatic actuator; and the first voltage is greater than the second voltage and the third voltage is greater than the fourth voltage. When a low voltage is applied to the first electrostatic actuator and a high voltage is applied to the second electrostatic actuator, the switch contact portion corresponding to the first electrostatic actuator is in disconnection and the switch contact portion corresponding to the second electrostatic actuator is in connection. Meanwhile, when a high voltage is applied to the first electrostatic actuator and a low voltage is applied to the second electrostatic actuator, the switch contact portion corresponding to the first electrostatic actuator is in connection and the switch contact portion corresponding to the second electrostatic actuator is in disconnection.

In the above-described switch, the first voltage may be equal to the fourth voltage and the second voltage may be equal to the third voltage. The switch contact portion corresponding to the first electrostatic actuator and the switch contact portion corresponding to the second electrostatic actuator can be operated by the same force. This enables a stable operation.

In the above-described switch, a voltage applied to the first electrostatic actuator may be changed from the first voltage to the third voltage and the voltage applied to the second electrostatic actuator is changed from the second voltage to the fourth voltage at the same time; and the voltage applied to the first electrostatic actuator may be changed from the third voltage to the first voltage and the voltage applied to the second electrostatic actuator is changed from the fourth voltage to the second voltage at the same time. An attractive force is applied onto one electrostatic actuator and a repulsive force is applied to the other electrostatic actuator at the same time. It is possible to prevent the phenomenon of being unopened in the switch having a torsion spring structure of a small spring constant, when the switch contact portion is opened and closed a number of times.

The above-described switch may further include an inverter that inverts a first drive signal that drives the first electrostatic actuator to output a second drive signal that drives the second electrostatic actuator, and the first drive signal may be applied to the first electrostatic actuator and the second drive signal is applied to the second electrostatic actuator. The first drive signal is inverted at the inverter to generate the second drive signal. With such a simple configuration, the voltage applied to one of the electrostatic actuators and the voltage applied to the other electrostatic actuator can be changed at the same time.

In the above-described switch, two torsion springs formed in a V-shaped manner may be secured to the beam portion. It is possible to suppress the displacement of the beam portion to the horizontal.

In the above-described switch, another torsion spring may be provided between the two torsion springs formed in the V-shaped manner. It is further possible to suppress the displacement of the beam portion to the horizontal.

In the above-described switch, the multiple sub beam portions and the multiple torsion springs may be alternately secured to the common portion. The beam portion can be held by the torsion springs in a well-balanced manner.

In the above-described switch, at least one of the multiple sub beam portions may include multiple switch contact portions electrically isolated from each other. The switch may be configured such that multiple switch contact portions electrically isolated from each other are simultaneously in connection or disconnection.

In the above-described switch, wiring electrodes may be respectively provided on the multiple torsion springs electrically coupled to a lower electrode of the electrostatic actuator. This configuration eliminates the necessity of providing the wiring coupled to the electrode of the electrostatic actuator, thereby reducing the size of the switch.

Although a few specific exemplary embodiments employed in the present invention have been shown and described, it would be appreciated by those skilled in the art that changes may be made in these exemplary embodiments without departing from the principles and spirit of the invention, the scope of which is defined in the claims and their equivalents.

The present invention is based on Japanese Patent Application No. 2005-338532 filed on Nov. 24, 2005, the entire disclosure of which is hereby incorporated by reference.

What is claimed is:

1. A switch comprising:
multiple torsion springs with each of one ends thereof secured to a substrate;
a beam portion, to which each of the other ends of the multiple torsion springs is secured, and which is swung by an electrostatic actuator; and
a switch contact portion in which a first contact provided at the beam portion and a second contact secured to the substrate are in connection or disconnection.

2. The switch as claimed in claim 1, wherein:
the beam portion includes multiple sub beam portions and a common portion to which each of the one ends of the multiple sub beam portions is secured;
the multiple torsion springs are secured to the common portion;
the multiple sub beam portions respectively include the electrostatic actuator and the first contact; and
multiple switch contact portions are provided to the first contact respectively provided at the multiple sub beam portions.

3. The switch as claimed in claim 2, wherein the multiple sub beam portions are two beam portions.

4. The switch as claimed in claim 2, wherein:
a first electrostatic actuator is provided at one of two sub beam portions opposing each other and interposing the common portion and a second electrostatic actuator is provided at the other of the two sub beam portions;
when a first voltage is applied to the first electrostatic actuator, a second voltage is applied to the second electrostatic actuator;
when a third voltage is applied to the first electrostatic actuator, a fourth voltage is applied to the second electrostatic actuator; and
the first voltage is greater than the second voltage and the third voltage is greater than the fourth voltage.

5. The switch as claimed in claim 4, wherein the first voltage is equal to the fourth voltage and the second voltage is equal to the third voltage.

6. The switch as claimed in claim 4, wherein:
a voltage applied to the first electrostatic actuator is changed from the first voltage to the third voltage and the voltage applied to the second electrostatic actuator is changed from the second voltage to the fourth voltage at the same time; and
the voltage applied to the first electrostatic actuator is changed from the third voltage to the first voltage and the voltage applied to the second electrostatic actuator is changed from the fourth voltage to the second voltage at the same time.

7. The switch as claimed in claim 4, further comprising an inverter that inverts a first drive signal that drives the first electrostatic actuator to output a second drive signal that drives the second electrostatic actuator,
wherein the first drive signal is applied to the first electrostatic actuator and the second drive signal is applied to the second electrostatic actuator.

8. The switch as claimed in claim 1, wherein two torsion springs formed in a V-shaped manner are secured to the beam portion.

9. The switch as claimed in claim 8, wherein another torsion spring is provided between the two torsion springs formed in the V-shaped manner.

10. The switch as claimed in claim 2, wherein the multiple sub beam portions and the multiple torsion springs are alternately secured to the common portion.

11. The switch as claimed in claim 1, wherein at least one of,the multiple sub beam portions includes multiple switch contact portions electrically isolated from each other.

12. The switch as claimed in claim 1, wherein wiring electrodes are respectively provided on the multiple torsion springs electrically coupled to a lower electrode of the electrostatic actuator.
